(19) United States
(12) Patent Application Publication
(10) Pub. No.: US 2010/0090889 A1
(43) Pub. Date: Apr. 15, 2010

(54) PRECISE ORBIT DETERMINATION SYSTEM AND METHOD USING GPS DATA AND GALILEO DATA

(76) Inventors: Yoola Hwang, Daejeon-city (KR); Byoung-Sun Lee, Daejeon-city (KR); Hae-Yeon Kim, Daejeon-city (KR); Jae-Hoon Kim, Daejeon-city (KR)

Correspondence Address: RABIN & Berdo, PC, 1101 14TH STREET, NW, SUITE 500, WASHINGTON, DC, 20005, US

(21) Appl. No.: 12/443,464

(22) PCT Filed: Sep. 17, 2007
(86) PCT No.: PCT/KR07/04463

§ 371 Date: Mar. 27, 2009

(30) Foreign Application Priority Data
Sep. 29, 2006 (KR) 10-2006-0096591

(51) Int. Cl. G01S 19/41

(52) U.S. Cl. 342/357.03; 342/357.04

(57) ABSTRACT

Provided are a method and system for determining a precise orbit of a LEO satellite. The method includes: estimating a precise ephemeris of a global positioning system (GPS) satellite by fitting an orbit perturbation-based GPS dynamics model to observation data of the GPS satellite received from a GPS observatory and estimating a precise ephemeris of a Galileo satellite by fitting an orbit perturbation-based Galileo dynamics model to observation data of the Galileo satellite received from a Galileo observatory; determining an initial orbit value of a LEO satellite by fitting an orbit perturbation-based LEO satellite's basic dynamics model to navigation data received from the LEO satellite; and determining the precise orbit of the LEO satellite by calculating a difference between observation values, which are calculated based on a GPS and Galileo data received from the LEO satellite, the GPS observatory and the Galileo observatory, and calculated values, which are calculated based on an orbit perturbation-based LEO satellite's dynamics model that was calculated using the initial orbit value of the LEO satellite and the precise ephemeris of the GPS and Galileo satellites. Since both the GPS and Galileo data are received and used to determine the precise orbit of a LEO satellite, more precise orbit determination can be achieved.

### TECHNICAL FIELD

The present invention relates to a precise orbit determination system and method using global positioning system (GPS) data and Galileo data, and more particularly, to a precise orbit determination system and method that can further improve the precision in orbit determination using both Galileo data and GPS data having high reliability, which are received by a combined receiver for receiving both the Galileo data and the GPS data.

### BACKGROUND ART

Global positioning system (GPS) is used to accurately measure the position of an object on and over the earth using satellites. The GPS, which was developed by the United States Department of Defense for military purposes, measures the position of an object using at least 24 satellites with such a high precision that there is an error of only 1 centimeter allowed in military use and 5 meters in civilian use. The GPS is now operated with 28 satellites orbiting the globe since the launching of its first GPS satellite in 1978. Each GPS satellite rotates the Earth twice a day at an altitude of 20,000 kilometers. GPS for military is used, for example, to attack a target object with high precision, and GPS for civilian has various applications, for example, in geodetic surveys, general surveys, scientific surveys, and visual synchronization, in addition to navigation systems of moving object for drivers.

In order to deal with the GPS monopolized by the USA, Europe which has relied on the USA's GPS, has started recently to operate a Galileo navigation system, its own global positioning system, and widened the worldwide distribution of sensor stations to provide civilians with more services and raise the reliability. Thus, the availability of Galileo data is expected to be worldwide. The Galileo navigation system, which costs 4.5 billion dollars (equivalent to 4.5 trillion won) just for development and whose first Galileo satellite named ‘Giove-A’ was launched, has a plan to put up 30 satellites by the year 2010.

The Galileo navigation system to be used for civilian makes a point of providing a better service than the USA's GPS, for example, by narrowing the error range within 1 meter. The Galileo navigation system also can capture a target object in a city or inside a building due to its excellent observation sensitivity, and it takes less time to identify the position of an object than the GPS.

A low-earth-orbiter (LEO) satellite control system has been able to acquire worldwide and continuous data using GPS data since the launch of the TOPEX/POSEIDON satellite. The successful mission performance of the TOPEX/POSEIDON satellite has become a starting point of precise orbit determination using GPS data, and most LEO satellites have been able to determine an orbit with a GPS receiver loaded thereon. Even though the precision in orbit determination using GPS data is currently highly accurate because of being free from selective availability (SA), it is uncertain when the SA will arise again and then the reliability of signals will drop.

Furthermore, a signal disconnection phenomenon frequently occurs while a moving object goes through a tunnel, under an overpass, or between high-rise buildings and therefore a user cannot be provided with continuous positioning service.

### DISCLOSURE OF INVENTION

### Technical Problem

It is required to precisely determine an orbit and position using a receiver both receiving GPS data and Galileo data, rather than using a GPS exclusive receiver, so that at least four signals that have highly reliability can be used in determining the orbit and position.

### Technical Solution

The present invention provides an orbit determination system and method for precisely determining an orbit of a LEO satellite using data from both GPS and Galileo satellites.

The present invention relates to a position determination system and method for precisely determining the position of a user using a combined receiver for GPS and Galileo data.

### Advantageous Effects

According to the present invention, both UPS and Galileo data is received in a LEO satellite, and a data format containing both types of data is defined, so that an orbit determination system can be established and used with improved convenience.

In addition, according to the present invention, both GPS and Galileo data is received, and data with high reliability is selected in consideration of the reliability and GDOP of the data. Since the Galileo data can be used even when the GPS data are not available, a signal disconnection phenomenon can be prevented.

Furthermore, since the Galileo data in addition to the GPS data is used, navigation satellites at a high altitude are available at any time. Accordingly, a service system that can provide the position of a user without a signal disconnection phenomenon even when the user passes between high-rise buildings can be established.

### DESCRIPTION OF DRAWINGS

The above and other features and advantages of the present invention will become more apparent by describing in detail exemplary embodiments thereof with reference to the attached drawings in which:

FIG. 1 is a diagram showing a structure of a satellite control system involved in precise orbit determination according to the present invention;

FIG. 2 is a block diagram of a system for determining a precise orbit of a LEO satellite according to an embodiment of the present invention;

FIG. 3 is a flowchart of a method of determining a precise orbit of a LEO satellite according to an embodiment of the present invention;

FIG. 4 is a flowchart of an operation of processing GPS and Galileo data received from the LEO satellite, according to an embodiment of the present invention;

FIG. 5 shows an example of a data format of a file containing both GPS and Galileo data according to the present invention;

FIG. 6 is a schematic block diagram of a system for determining the position of a user using GPS and Galileo data, according to an embodiment of the present invention; and

FIG. 7 is a flowchart of a method of determining the position of a user using GPS and Galileo data, according to an embodiment of the present invention.

### BEST MODE

According to an aspect of the present invention, there is provided a system for determining a precise orbit of a LEO satellite, the system comprising: a global positioning system (GPS) and Galileo satellites' precise ephemeris determination unit estimating a precise ephemeris of a GPS satellite by fitting an orbit perturbation-based GPS dynamics model to observation data of the GPS satellite received from a GPS observatory and estimating a precise ephemeris of a Galileo satellite by fitting an orbit perturbation-based Galileo dynamics model to observation data of the Galileo satellite received from a Galileo observatory; a LEO satellite's initial orbit value determination unit determining an initial orbit value of a LEO satellite by fitting an orbit perturbation-based LEO satellite's basic dynamics model to navigation data received from the LEO satellite; and a LEO satellite's precise orbit determination unit determining the precise orbit of the LEO satellite by calculating a difference between observation values using GPS and Galileo data received from the LEO satellite, the GPS observatory and the Galileo observatory, and calculated values based on LEO satellite's dynamics model that was calculated using the initial orbit value of the LEO satellite and the precise ephemeris of the GPS and Galileo satellites.

According to another aspect of the present invention, there is provided a method of determining a precise orbit of a LEO satellite, the method comprising: estimating a precise ephemeris of a global positioning system (GPS) satellite by fitting an orbit perturbation-based GPS dynamics model to observation data of the GPS satellite received from a GPS observatory and estimating a precise ephemeris of a Galileo satellite by fitting an orbit perturbation-based Galileo dynamics model to observation data of the Galileo satellite received from a Galileo observatory; determining an initial orbit value of a LEO satellite by fitting an orbit perturbation-based LEO satellite's basic dynamics model to navigation data received from the LEO satellite; and determining the precise orbit of the LEO satellite by calculating a difference between observation values using GPS and Galileo data received from the LEO satellite, the GPS observatory and the Galileo observatory, and calculated values based on LEO satellite's dynamics model that was calculated using the initial orbit value of the LEO satellite and the precise ephemeris of the GPS and Galileo satellites.

According to another aspect of the present invention, there is provided a method for determining the position of a user, the method comprising: receiving both global positioning system (GPS) and Galileo data simultaneously; determining the ephemeris of GPS and Galileo satellites by fitting orbit-perturbation based dynamics models to the received GPS and Galileo data, respectively; evaluating the reliability of the GPS and Galileo data, calculating a geometric dilution of precision (GDOP) of the GPS and Galileo data, and correcting a transmission error and an error inherent in the GPS and Galileo data; and determining the position of the user using the processed data and ephemeris of the GPS and Galileo satellites.

According to another aspect of the present invention, there is provided a system for determining the position of a user, the system comprising: a GPS/Galileo data reception unit receiving both GPS and Galileo simultaneously; an ephemeris determination unit determining the ephemeris of GPS and Galileo satellites by fitting orbit-perturbation based dynamics models to the received GPS and Galileo data, respectively; a data process unit evaluating the reliabilities of the GPS and Galileo data, calculating a geometric dilution of precision (GDOP) of the GPS and Galileo data, and correcting a transmission error and an error inherent in the GPS and Galileo data; and a position determination unit determining the position of the user using the data output from the data process unit and the of the GPS and Galileo satellites.

According to another aspect of the present invention, there is provided a computer readable recording medium having embodied thereon a program for any one of the method for determining a precise orbit of a LEO satellite and the method for determining the position of a user.

### Mode for Invention

Hereinafter, the present invention will be described in detail by explaining exemplary embodiments of the invention with reference to the attached drawings. Like reference numerals in the drawings denote like elements. In the following description, detailed descriptions on related disclosed functions or structures are not provided if they could make the subject matter of the present invention unclear.

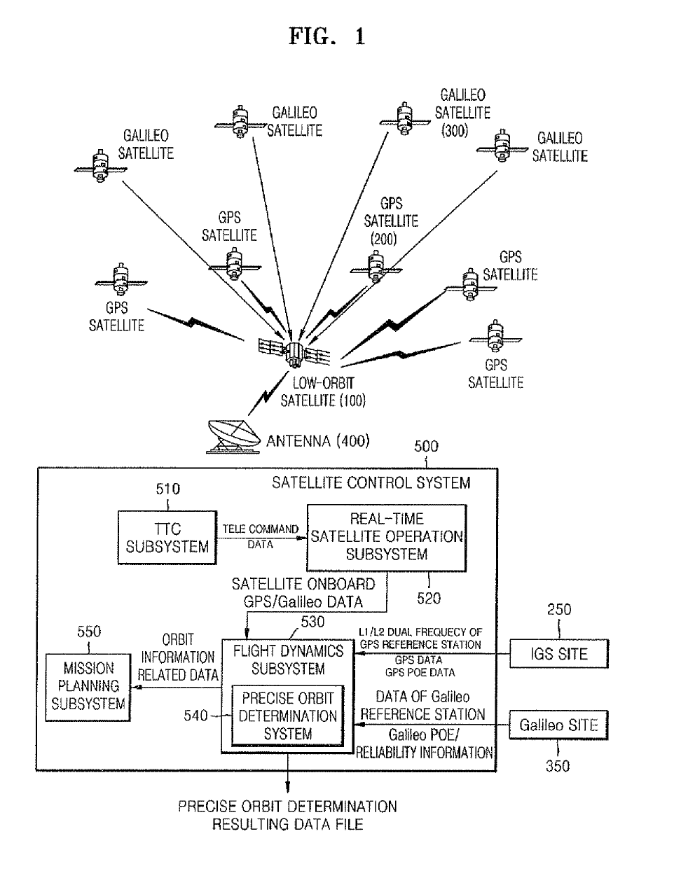

FIG. 1 is a diagram showing a structure of a satellite control system involved in precise orbit determination according to the present invention.

Referring to FIG. 1, a LEO satellite 100 receives global positioning system (GPS) data from a GPS satellite 200 and Galileo data from a Galileo satellite 300. The GPS and Galileo data, which are raw and onboard data, received by the LEO satellite 100, and the status information and other items of information of other satellites are transmitted to a TTC (Telemetry, Tracking and Command) subsystem 510 of the satellite control system 500 via an antenna 400. The TTC subsystem 510 processes and transmits the transmitted data with real-time telecommand data to a real-time satellite operation subsystem 520.

The real-time operation subsystem 520 transmits the GPS and Galileo data received from the LEO satellite 100 to a flight dynamics subsystem 530. The flight dynamics subsystem 530 is mainly responsible for the substantial operation of satellites and includes a precise orbit determination system 540, which determines a precise orbit of the satellite.

The precise orbit determination system 540 determines a precise orbit by processing raw data received from an IGS (International Global Navigation Satellite System Service) site 250, a Galileo site 350, and the GPS and Galileo data, performing estimation, etc. Data of the precisely determined orbit is transmitted to another external site.

In addition, an orbit data maneuver request or orbit information related data predicted by the flight dynamics subsystem 530 is transmitted to a mission planning subsystem 550.

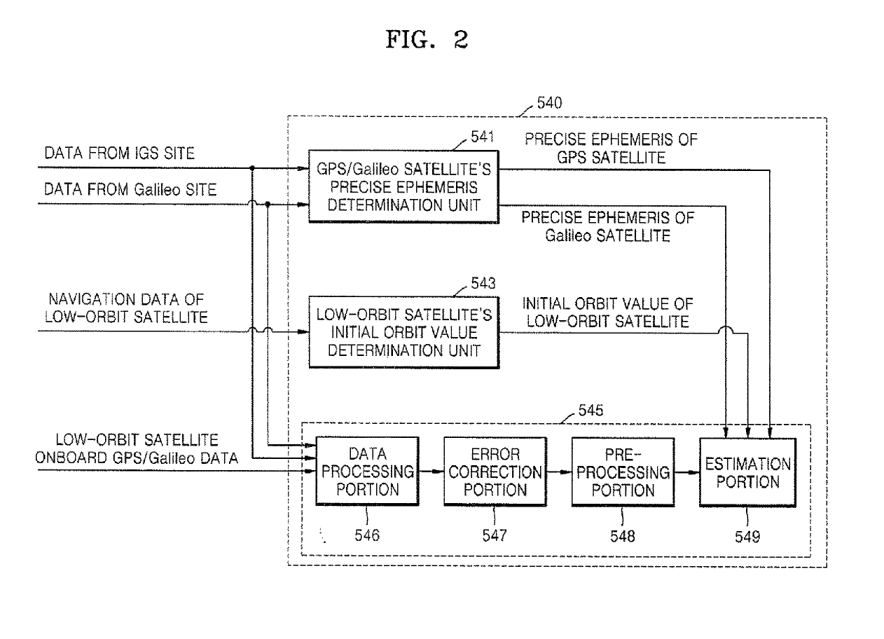

FIG. 2 is a block diagram of the precise orbit determining system 540 according to an embodiment of the present invention. The present invention applies a differential GPS (DGPS), and detailed descriptions of disclosed technologies relating to the present invention will not be described here.

Referring to FIG. 2, the precise orbit determination system 540 includes a GPS/Galileo satellite's precise ephemeris determination unit 541, a LEO satellite's initial orbit value determination unit 543, and a LEO satellite's precise orbit determination unit 545.

The GPS/Galileo satellite's precise ephemeris determination unit 541 receives the GPS data received at each regular GPS observatory from the IGS site 250. Also, the GPS/Galileo satellite's precise ephemeris determination unit 541 receives the Galileo data received at each Galileo observatory from the Galileo site 350. These pieces of data include information from which the distance from the GPS and Galileo satellites to the receiver can be found, such as, values obtained using the time at which data is received at an observatory receiver from each of the GPS and Galileo satellites, a distance value obtained by multiplying the time by the speed of light, or a value obtained by using phase difference.

If the data from the IGS site 250 and the Galileo site 350 does not include information on the precise ephemeris of the GPS and Galileo satellites, the precise ephemeris of each of the GPS and Galileo satellites is estimated by fitting a dynamics model to the observation data of each of the GPS and Galileo satellites received from the IGS site 250 and the Galileo site 350. The dynamics models are calculated values predicted by modeling in consideration of perturbations of the GPS and Galileo satellites caused by, for example, a gravitational field, air resistance, or solar wind pressure.

The precise ephemeris of each of the GPS and Galileo satellites is determined by setting an initial orbit value from broadcast data of each of the GPS and Galileo satellites and minimizing a difference between the orbit data of each of the GPS and Galileo satellites provided in real time or semi-real time and the dynamics model for each of the UPS and Galileo satellites, i.e., a difference between the observation values and the calculated values.

The LEO satellite's initial orbit value determination unit 543 calculates an initial orbit value required to determine a precise orbit of the LEO satellite. In particular, the LEO satellite's initial orbit value determination unit 543 sets an approximate basic dynamics model for the LEO satellite based on navigation data, exclusive of the GPS and Galileo data, received from the LEO satellite, and fits the dynamics model to the navigation data of the LEO satellite, thereby determining the initial orbit value of the LEO satellite that optimizes a difference between the navigation data and the dynamics model.

The LEO satellite's precise orbit determination unit 545 includes a data processing portion 546, an error correction portion 547, a pre-processing portion 548, and an estimation portion 549.

391 The data processing portion 546 processes GPS and Galileo data from the LEO satellite 100. Initially, the data processing portion 546 generates a single file in a new format containing both the GPS and Galileo data received by the LEO satellite, checks the magnitude of signals for the GPS and Galileo data in the file, and evaluates reliabilities of the UPS and Galileo data. Next, the data processing portion 546 calculates the geometric dilution of precision (GDOP) of the GPS and Galileo data. And then the data processing portion 546 chooses data having a high quality. The GPS and Galileo data of the LEO satellite include information from which the distance from the GPS and Galileo satellite to the receiver can be found, such as, values obtained using the time at which data is received by a receiver of the LEO satellite from each of the GPS and Galileo satellites, a distance value obtained by multiplying the time by the speed of light, or a value obtained by using phase difference.

The error correction portion 547 may correct an error to the chosen GPS and Galileo data, and the GPS and Galileo data from the ground station (the IGS site 250 and the Galileo site 350) or may estimate an error value. Possible errors which may occur when the receiver receives data include a satellite's visibility range alternations, a satellite's orbit alternations, a propagation delay due to radio waves passing through the atmosphere, etc. However, such error factors cannot be predicted in the receiver. Accordingly, errors, such as, a transmission error of the data and an error inherent in the data, need to be measured and corrected. To this end, such errors may be corrected by modeling a tropospheric path delay effect, an isonospheric path delay effect, a relativistic effect, lithospheric and ocean tidal effects, etc. The error correction can be performed after the pre-processing by the pre-processing portion 548 or during estimation portion 549.

The pre-processing portion 548 pre-processes the error-corrected data by performing a double differential or triple differential method to obtain observation values, which will be used in later filter estimation.

The estimation portion 549 applies a filter theory adjusting observation data and calculated values. The calculated values are calculated based on the dynamics model such as the gravitational field, air resistance, and solar wind pressure influencing on the LEO satellite, with the initial orbit value of the LEO satellite, and the precise ephemeris of the GPS and Galileo satellites. The observation data are obtained based on the pre-processed observation data. And the estimation portion 549 estimates estimation parameters minimizing a difference between the calculated values and the observation values, and determines the precise orbit of the LEO satellite based on the estimation parameters.

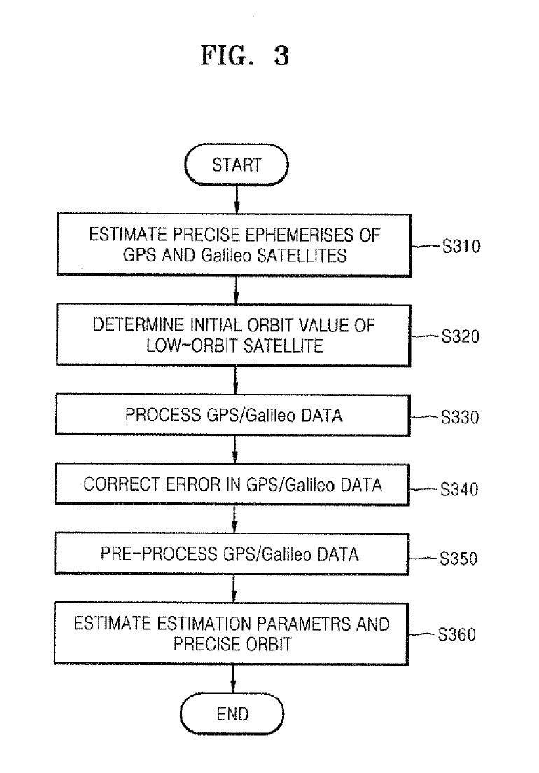

FIG. 3 is a flowchart of a method of determining a precise orbit of the LEO satellite according to an embodiment of the present invention.

Referring to FIG. 3, the method of determining a precise orbit of the LEO satellite according to an embodiment of the present invention includes estimating the precise ephemerises of GPS and Galileo satellites, determining an initial orbit value of the LEO satellite, and determining the precise orbit of the LEO satellite using these data.

The precise ephemeris of the GPS satellite is determined by receiving the precise ephemeris of the GPS satellite or ultra-rapid data from a IGS site 250 in FIG. 1 or by estimating the precise ephemeris of the GPS satellite by fitting a dynamics model for the GPS satellite to GPS navigation message data or raw data from the IGS site 250 in order to reduce a difference between the observation data from the IGS site and the calculated data by dynamics model. In addition, the precise ephemeris of the Galileo satellite is determined by receiving the precise ephemeris of the Galileo satellites from a Galileo site 350 in FIG. 1 or by estimating the precise ephemeris of the Galileo satellite by fitting a dynamics model for the Galileo satellite to the observation data from the Galileo satellite in order to reduce a difference between the observation data and the calculated data by dynamics model (operation S310). The dynamics models are calculated values predicted by modeling in consideration of perturbations for the GPS and Galileo satellites caused by, for example, the gravitational field, air resistance, and solar wind pressure.

The initial orbit value of a priori orbit of the LEO satellite is determined by receiving navigation data, exclusive of GPS and Galileo data, from the LEO satellite and setting an approximate basic dynamics model for the LEO satellite to minimize a difference between the navigation data of the LEO satellites and the calculated data by the basic dynamics model (operation S320).

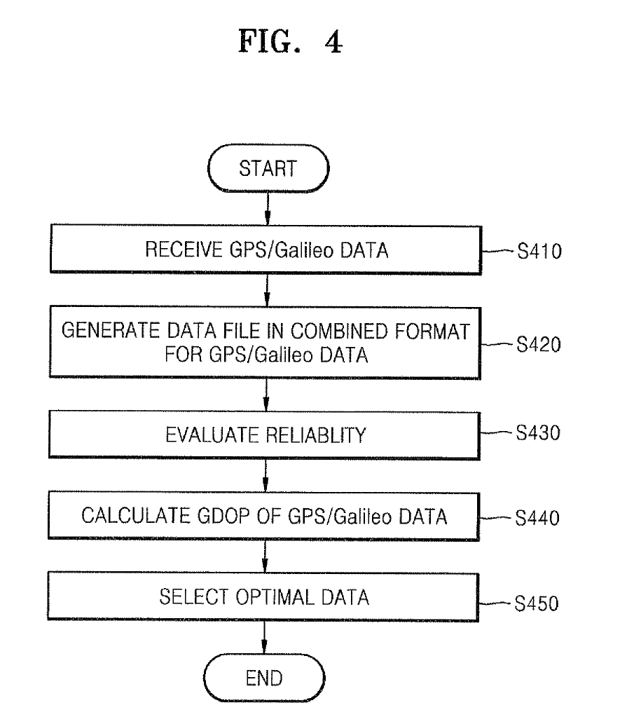

Next, the GPS and Galileo data received from the IGS site and Galileo site, and the GPS and Galileo data received from the LEO satellite is processed (operation S330). This data processing operation will be described in detail with reference to FIG. 4.

Referring to FIG. 4, the GPS and Galileo data is received from the LEO satellite (operation S410). A combined file in a new format containing both the GPS and Galileo satellites' data is generated from the received data (operation S420). The strengths of signals for the satellite data in the generated file are checked and the reliability of the satellite data is evaluated (operation S430). After the reliability evaluation, the GDOP for the satellite data is calculated (operation S440), and satellite data with high quality for orbit determination is selected from among the GPS and Galileo satellites' data (operation S450).

Referring back to FIG. 3, an error in the selected data, and the GPS and Galileo data received from the IGS site and Galileo site is corrected by modeling a troposphere path delay effect, an ionosphere path delay effect, a relativistic effect, lithosphere and ocean tidal effects, etc (operation S340).

Next, the corrected GPS and Galileo data is pre-processed by performing a double differential or triple differential method in order to obtain observation values (S350).

A more precise dynamics model for the LEO satellite than the approximate basic dynamics model applied when determining the initial orbit value of the LEO satellite is set. Next, estimation parameters minimizing an error between the observation values and a calculated values based on the set of the precise dynamics model and the precise ephemeris of the GPS and the Galileo satellites, and propagated LEO satellite ephemeris using initial LEO satellite orbit are estimated by applying a filter theory to the calculated values and the observation values, and the precise orbit of the LEO satellite is determined based on the estimation parameters (operation S360). The dynamics model used is calculated values predicted by modeling in consideration of perturbations for, for example, the gravitational field, air resistance, and solar wind pressure influencing the LEO satellite.

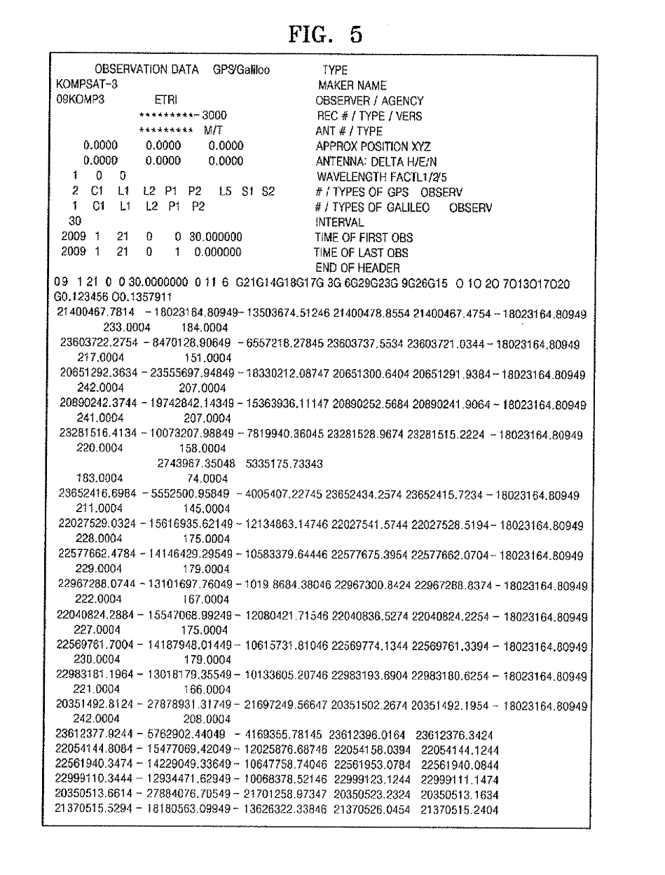

FIG. 5 shows an example of a single file in a Receiver Independent Exchange Format Version (RINEX) format, which is a new format containing both GPS and Galileo data and which is generated so as to process data determining the precise orbit of the LEO satellite.

The file is divided into a portion describing the file format such as RINEX in a header and a portion describing observation data. A portion defining an observation data type is divided into a GPS satellite portion and a Galileo satellite portion with the same format as the conventional RINEX format. The portion describing the observation data includes a Galileo satellite portion subsequent to a GPS satellite portion, wherein there are the number of Galileo satellites subsequent to the number of GPS satellites based on data types. In a line describing each epoch(measurement time satellite's data) of the GPS and Galileo satellites' data, the number of GPS satellites is defined in the conventional RINEX format, and the number of Galileo satellites at the epoch equivalent to the epoch of the Galileo data is defined next to the number of GPS satellites. For a GPS satellite, a mark ‘G’ is followed by the identification number of the GPS satellite. For a Galileo satellite, a mark ‘O’ is followed by the identification number of the Galileo satellite. On the other hand, a time tag value for the GPS satellite is written immediately after the mark ‘G’, whereas a time tag value for the Galileo satellite is written immediately after the mark ‘O’. Next, from a line following this description, observation data values are written in the given order of the identification numbers of the GPS and Galileo satellites. Most portions of the format excluding the features described above are the same as the conventional RINEX format.

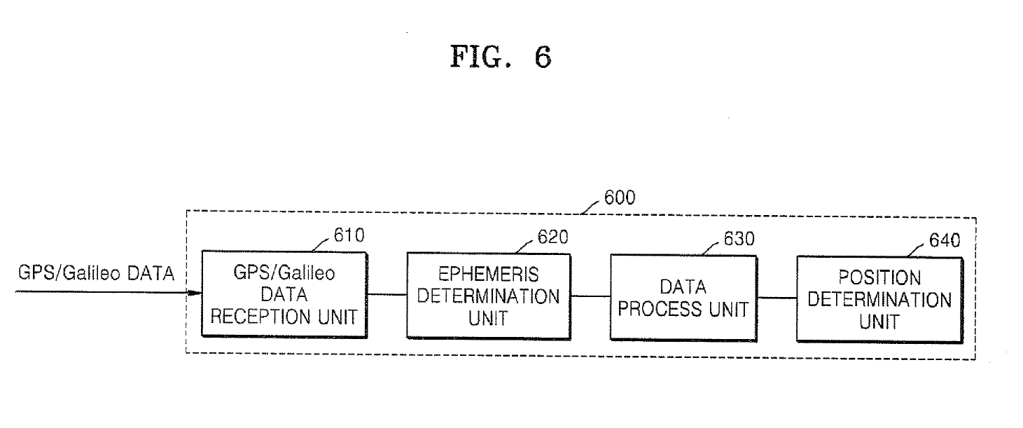

FIG. 6 is a schematic block diagram of a system for determining the position of a user by using GPS and Galileo data, according to an embodiment of the present invention.

Referring to FIG. 6, a user position determination system 600 includes a GPS and

Galileo data reception unit 610, an ephemeris determination unit 620, a data process unit 630, and a position determination unit 640.

The GPS/Galileo data reception unit 610 receives both GPS and Galileo broadcast data simultaneously. The ephemeris determination unit 620 determines an approximate ephemeris of a GPS satellite by fitting a dynamics model for the GPS satellite to GPS broadcast data, and determining an appropriate ephemeris of a Galileo satellite by fitting a dynamics model for the Galileo satellite to Galileo broadcast data.

The data process unit 630 evaluates the reliability of a satellite data of Galileo and GPS satellites, calculates the GDOP of the satellite data, selects satellite data with high quality, and corrects a transmission error and an error inherent in the satellite data.

The position determination unit 640 determines the position of the user by using the ephemeris of the GPS and Galileo satellites and the corrected measurement data, and applying various methods, such as a Least-square method, a filter theory, etc.

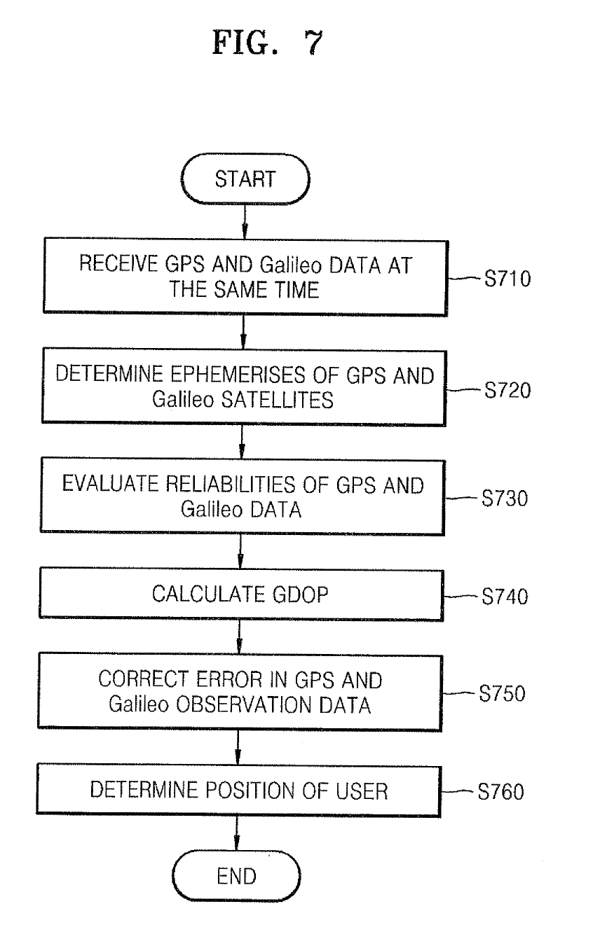

FIG. 7 is a flowchart of a method of determining the position of a user by using GPS and Galileo data, according to an embodiment of the present invention. Some of the operations involved in the position determination method which are similar to or the same as the operations described above in connection with the precise orbit determination method for the LEO satellite will not be repeated here and the above-description can be referred to if required.

The position determination method includes receiving OPS and Galileo data at the same time (operation S710) and determining the ephemerises of the GPS and Galileo satellites by fitting an orbital perturbation-based dynamics model to each of the received GPS and Galileo data (operation S720). These dynamics models are calculated values predicted by modeling in consideration of perturbations for, for example, the gravitational field, air resistance, and solar wind pressure influencing on the GOS and Galileo satellites.

The reliability of the received GPS and Galileo data are evaluated (operation S730), the GDOP of the GPS and Galileo data is calculated (operation S740), and then a transmission error and an error inherent in the data are corrected (operation S750).

The position of the user is determined using the processed satellite data and the ephemerises of the GPS and Galileo satellites (operation S760).

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers of ordinary skill in the art to which the present invention pertains.

The present invention has been described above with reference to exemplary embodiments. Although specific terms have been used in the exemplary embodiments, they should be considered for descriptive purposes, and not for defining their meaning or the scope of the present invention.

While this invention has been particularly shown and described with reference to the exemplary embodiments thereof, it will be understood by those of ordinary skill in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

1. A system for determining a precise orbit of a low-earth-orbiter (LEO) satellite, the system comprising:
a global positioning system (GPS) and Galileo satellites' precise ephemeris determination unit estimating a precise ephemeris of a GPS satellite by fitting an orbit perturbation-based GPS dynamics model to observation data of the GPS satellite received from a GPS observatory and estimating a precise ephemeris of a Galileo satellite by fitting an orbit perturbation-based Galileo dynamics model to observation data of the Galileo satellite received from a Galileo observatory;
a LEO satellite's initial orbit value determination unit determining an initial orbit value of a LEO satellite by fitting an orbit perturbation-based LEO satellite's basic dynamics model to navigation data received from the LEO satellite; and
a LEO satellite's precise orbit determination unit determining the precise orbit of the LEO satellite by calculating a difference between observation values, which are calculated based on a GPS and Galileo data received from the LEO satellite, the GPS observatory and the Galileo observatory, and calculated values, which are calculated based on an orbit perturbation-based LEO satellite's dynamics model with the initial orbit value of the LEO satellite and the precise ephemeris of the GPS and Galileo satellites.

2. The system of claim 1, wherein the LEO satellite's precise orbit determination unit comprises:
a data processing portion evaluating reliabilities of the GPS and Galileo data from the LEO satellite and calculating a geometric dilution of precision (GDOP) of the GPS and Galileo data in order to select satellite data with high quality;
an error correction portion correcting a transmission error and an error inherent in the selected data and the GPS and Galileo data from the GPS observatory and the Galileo observatory;
a pre-processing portion pre-processing the corrected data by performing a double differential method to obtain observation values; and
an estimation portion estimating estimation parameters by applying a filter theory to obtain the difference between the observation values and the calculated values, and estimating the precise orbit of the LEO satellite based on the estimation parameters.

3. The system of claim 2, wherein the data processing portion generates a data file in a combined format enabling the GPS and Galileo data received at the same time to be processed simultaneously; and evaluates the reliabilities and calculates the GDOP of the data in the generated file, and selects data with high quality.

4. The system of claim 3, wherein the data file in the combined format includes a GPS satellite portion and a Galileo satellite portion, and the GPS and Galileo data are written in the GPS and Galileo satellite portions according to a predetermined rule.

5. The system of claim 2, wherein the estimation portion estimates the precise orbit of the LEO satellite by minimizing the difference between the observation values and the calculated values.

6. The system of claim 1, wherein the GPS and Galileo satellites' precise ephemeris determination unit determines the precise ephemerises of the GPS and Galileo satellites by determining an initial orbit value from broadcast data of each of the GPS and Galileo satellites and minimizing a difference between an orbit data of each of the GPS and Galileo satellites provided in real time and a calculated data by the dynamics model for each of the GPS and Galileo satellites.

7. A method of determining a precise orbit of a low-earth-orbiter (LEO) satellite, the method comprising:
estimating a precise ephemeris of a global positioning system (GPS) satellite by fitting an orbit perturbation-based GPS dynamics model to observation data of the GPS satellite received from a GPS observatory and estimating a precise ephemeris of a Galileo satellite by fitting an orbit perturbation-based Galileo dynamics model to observation data of the Galileo satellite received from a Galileo observatory;
determining an initial orbit value of a LEO satellite by fitting an orbit perturbation-based LEO satellite's basic dynamics model to navigation data received from the LEO satellite; and
determining the precise orbit of the LEO satellite by calculating a difference between observation values, which are calculated based on a GPS and Galileo data received from the LEO satellite, the GPS observatory and the Galileo observatory, and calculated values, which are calculated based on an orbit perturbation-based LEO satellite's dynamics model with the initial orbit value of the LEO satellite and the precise ephemeris of the GPS and Galileo satellites.

8. The method of claim 7, wherein the determining of the precise orbit of the LEO satellite comprises:
selecting satellite data with high quality by evaluating reliability of the GPS and Galileo data from the LEO satellite and calculating a geometric dilution of precision (GDOP) of the GPS and Galileo data;
correcting a transmission error and an error inherent in the selected data and the GPS and Galileo data from the GPS observatory and the Galileo observatory;
pre-processing the corrected data by performing a double differential method to obtain observation values; and
estimating the precise orbit of the LEO satellite based on estimation parameters, which are calculated by applying a filter theory to obtain the difference between the observation values and the calculated values.

9. The method of claim 8, wherein the selecting of the satellite data with high quality comprises:
generating a data file in a combined format enabling the GPS and Galileo data received at the same time to be processed simultaneously; and
evaluating the reliability and calculating the GDOP of the data in the generated file, and selecting the data with high quality.

10. The method of claim 8, wherein the estimating of the precise orbit of the LEO satellite comprises minimizing the difference between the observation values and the calculated values.

11. The method of claim 7, wherein the determining of the precise ephemerises of the GPS and Galileo satellites comprises:
determining an initial orbit value from broadcast data of each of the GPS and Galileo satellites and minimizing a difference between an orbit data of each of the GPS and Galileo satellites provided in real time and a calculated data by the dynamics model for each of the GPS and Galileo satellites.

12. A method of determining the position of a user, the method comprising:
receiving both global positioning system (GPS) and Galileo data simultaneously;
determining the ephemerises of GPS and Galileo satellites by fitting orbit-perturbation based dynamics models to the received GPS and Galileo data, respectively;
evaluating the reliability of the GPS and Galileo data, calculating a geometric dilution of precision (GDOP) of of the GPS and Galileo data, and correcting a transmission error and an error inherent in the GPS and Galileo data; and
determining the position of the user using the processed data and the ephemerises of the GPS and Galileo satellites.

13. A system for determining the position of a user, the system comprising:
a GPS/Galileo data reception unit receiving both GPS and Galileo simultaneously;
an ephemeris determination unit determining the ephemerises of GPS and Galileo satellites by fitting orbit-perturbation based dynamics models to the received GPS and Galileo data, respectively;
a data process unit evaluating the reliabilities of the GPS and Galileo data, calculating a geometric dilution of precision (GDOP) of the GPS and Galileo data, and correcting a transmission error and an error inherent in the GPS and Galileo data; and
a position determination unit determining the position of the user using the data output from the data process unit and the ephemerises of the GPS and Galileo satellites.

14. A computer readable recording medium having embodied thereon a program for executing the method of claim 12.

15. A computer readable recording medium having embodied thereon a program for executing the method of claim 11.

16. A computer readable recording medium having embodied thereon a program for executing the method of claim 10.

17. A computer readable recording medium having embodied thereon a program for executing the method of claim 9.

18. A computer readable recording medium having embodied thereon a program for executing the method of claim 8.

19. A computer readable recording medium having embodied thereon a program for executing the method of claim 7.
